(19) United States
(12) Patent Application Publication
(10) Pub. No.: US 2016/0106279 A1
(43) Pub. Date: Apr. 21, 2016

(54) Autonomous Stair Climbing and Surface Cleaning Apparatus and System

(71) Applicant: Duane Leigh Gilbert, JR., Quincy, MA (US)

(72) Inventor: Duane Leigh Gilbert, JR., Quincy, MA (US)

(21) Appl. No.: 14/884,311

(22) Filed: Oct. 15, 2015

Related U.S. Application Data
(60) Provisional application No. 62/064,736, filed on Oct. 16, 2014.

(51) Int. Cl. A47L 9/00; A47L 9/28; B60S 9/205; A47L 5/22

(52) U.S. Cl. CPC A47L 9/009; A47L 5/22; A47L 9/2873; B60S 9/205

(57) ABSTRACT

An autonomous stair climbing platform and surface cleaning apparatus, systems, and methods may be provided. Embodiments of the present disclosure may comprise an autonomous surface cleaning robot capable of ascending and descending stairs a single tread at a time such that each stair can be cleaned in addition to all other floor surfaces. In addition the stair climbing mobility system further allows a plurality of other functions, including, but not limited to telepresence, payload delivery or communication that is not limited to a single level as is the case with currently available systems.

### RELATED APPLICATION

Under provisions of 35 U.S.C. §119(e), the Applicant claims the benefit of U.S. provisional application no. 62/064,736, filed Oct. 16, 2014, which is incorporated herein by reference. It is intended that each of the referenced applications may be applicable to the concepts and embodiments disclosed herein, even if such concepts and embodiments are disclosed in the referenced applications with different limitations and configurations and described using different examples and terminology.

### FIELD OF DISCLOSURE

The present disclosure generally relates to robotic systems.

### BACKGROUND

Automatic vacuuming robots exist in the current market. However, presently, there are no automatic vacuuming robots capable of climbing stairs and vacuuming each stair. Further current automatic vacuuming robots have small storage capacity and are unable to automatically dump their contents.

### BRIEF OVERVIEW

This brief overview is provided to introduce a selection of concepts in a simplified form that is further described below in the Detailed Description. This brief overview is not intended to identify key features or essential features of the claimed subject matter. Nor is this brief overview intended to be used to limit the claimed subject matter's scope.

An autonomous stair climbing platform and surface cleaning apparatus, systems, and methods may be provided. Embodiments of the present disclosure may comprise an autonomous surface cleaning robot capable of ascending and descending stairs a single tread at a time such that each stair can be cleaned in addition to all other floor surfaces. In addition the stair climbing mobility system further allows a plurality of other functions, including, but not limited to telepresence, payload delivery or communication that is not limited to a single level as is the case with currently available systems.

Consistent with embodiments of the present disclosure, an autonomous stair climbing apparatus may be provided. The apparatus may comprise: a body comprising: a power source, at least one wheel, at least one motor coupled to the power source and the at least one wheel and configured to drive the at least one wheel; at least one arm coupled to the body and to an arm motor configured to rotate around the body, the at least one arm comprising an end configured to sit against a base of an elevated surface, the arm being; and a spring system configured to be loaded by a spring motor, wherein a release of the spring system enables a kinetic energy necessary to propel the body over the elevated surface by pivoting around the end configured to sit against the base of the elevated surface.

Still consistent with embodiments of the present disclosure, an autonomous stair climbing method may be provided. The method may comprise: placing a front part of at least one arm against a base of an elevated surface; orienting a body that is connected to a rear part of the at least one arm such that the body's center of mass is higher than the base of the stair; loading a spring, wherein one side of the spring is connected to the at least one arm and the other side of the spring is connected to the body; releasing the spring's load, wherein the releasing of the spring causes the body to cause a force against the at least one arm, thereby causing a rotational motion such that the body vaults over the elevated surface.

Both the foregoing brief overview and the following detailed description provide examples and are explanatory only. Accordingly, the foregoing brief overview and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the Applicants. The Applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure. In the drawings:

FIG. 1A is an illustration of a central body;

FIG. 1B is another illustration of the central body;

FIG. 2A is an illustration of a secondary ring body;

FIG. 2B is another illustration of the secondary ring body;

FIG. 3 is an illustration of an outer body;

FIG. 4A is an illustration of a spring system;

FIG. 4B is another illustration of the spring system;

FIG. 5 is an illustration of an outer body;

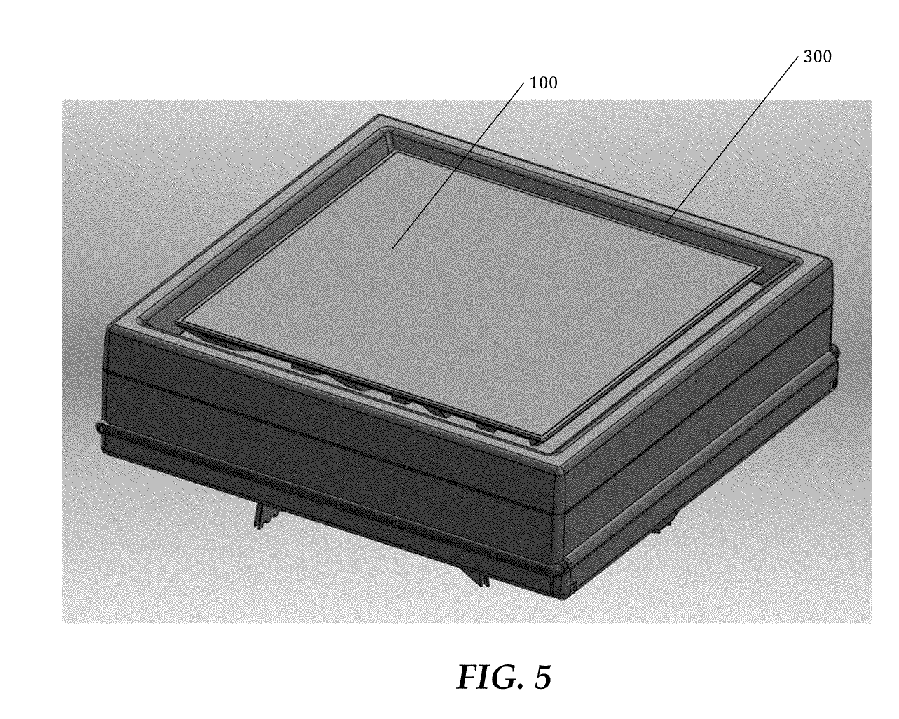

FIG. 6 is an illustration of a motor for cleaning drives;

FIG. 7 is an illustration of an outer body;

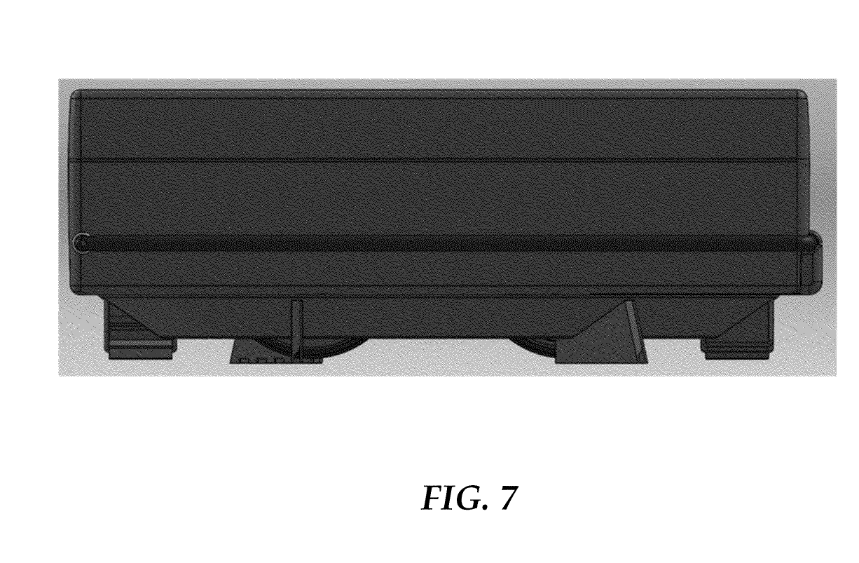

FIG. 8A is an illustration of a wheel configuration;

FIG. 8B is another illustration of the wheel configuration;

FIG. 8C is another illustration of the wheel configuration;

FIG. 8D is another illustration of the wheel configuration;

FIG. 9 is an illustration of an optical tracking system;

FIG. 10 is an illustration of underbody drive mechanism, corner cleaning air jets;

FIG. 11A is another illustration of underbody drive mechanism, corner cleaning air jets;

FIG. 11B is another illustration of underbody drive mechanism, corner cleaning air jets;

FIG. 12A is an illustration of a climbing mechanism;

FIG. 12B is another illustration of the climbing mechanism;

FIG. 13 is an illustration of a diffuser;

FIG. 14 is a block diagram of a system including a controller for performing the method described below; and

FIG. 15 is a flow chart illustration an operation of a method consistent with embodiments of the present disclosure.

### DETAILED DESCRIPTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Regarding applicability of 35 U.S.C. §112, ¶6, no claim element is intended to be read in accordance with this statutory provision unless the explicit phrase “means for” or “step for” is actually used in such claim element, whereupon this statutory provision is intended to apply in the interpretation of such claim element.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present disclosure contains headers. It should be understood that these headers are used as references and are not to be construed as limiting upon the subjected matter disclosed under the header.

The present disclosure includes many aspects and features. Moreover, while many aspects and features relate to, and are described in, the context of cleaning, embodiments of the present disclosure are not limited to use only in this context, including, but not limited to telepresence, payload delivery or communication that is not limited to a single level as is the case with currently available systems.

I. Configuration

Embodiments of the present disclosure may be comprised of an autonomous stair climbing platform. Components comprising embodiments of the present disclosure may be configured as part of a floor cleaning device such that it is sized to fit on a staircase and under kitchen counters (e.g. “toe kicks”). A standard stair tread (run) is 10″ wide, and standard riser is 7″ tall. Standard US based toe kick height is 4″, but can be as low as 3.5″ depending on installation. As such, embodiments of this invention may be 9.5″×9.5″×3.25″. This cleaning device may be configured to self-dock, charge, and empty debris into a larger receptacle located at the dock in order minimize user interaction. The mobility platform of this cleaning device can be separately configured to carry numerous other payloads, or perform telepresence, and communications while successfully climbing stairs.

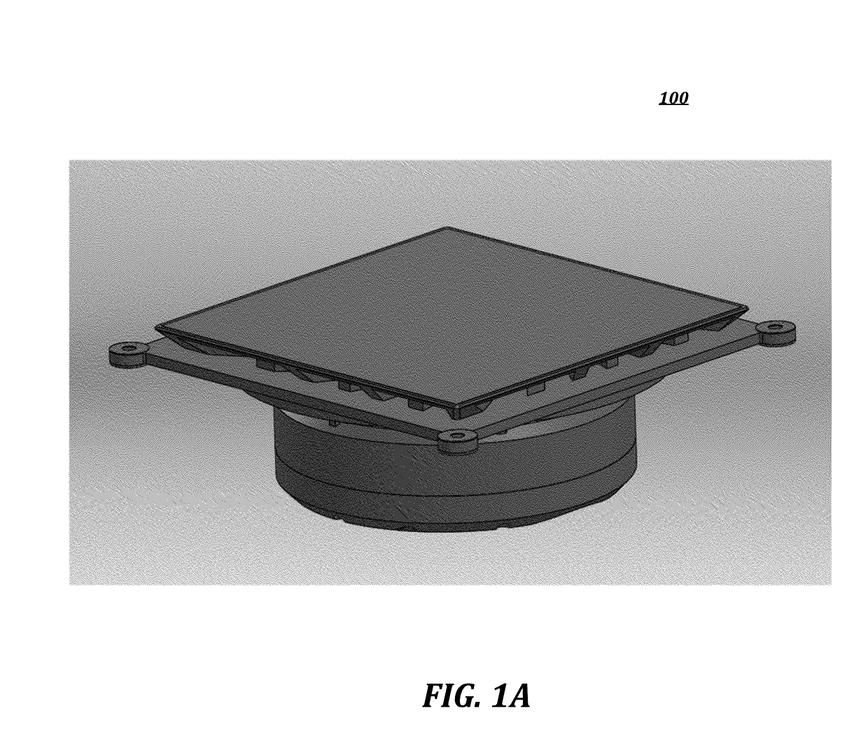

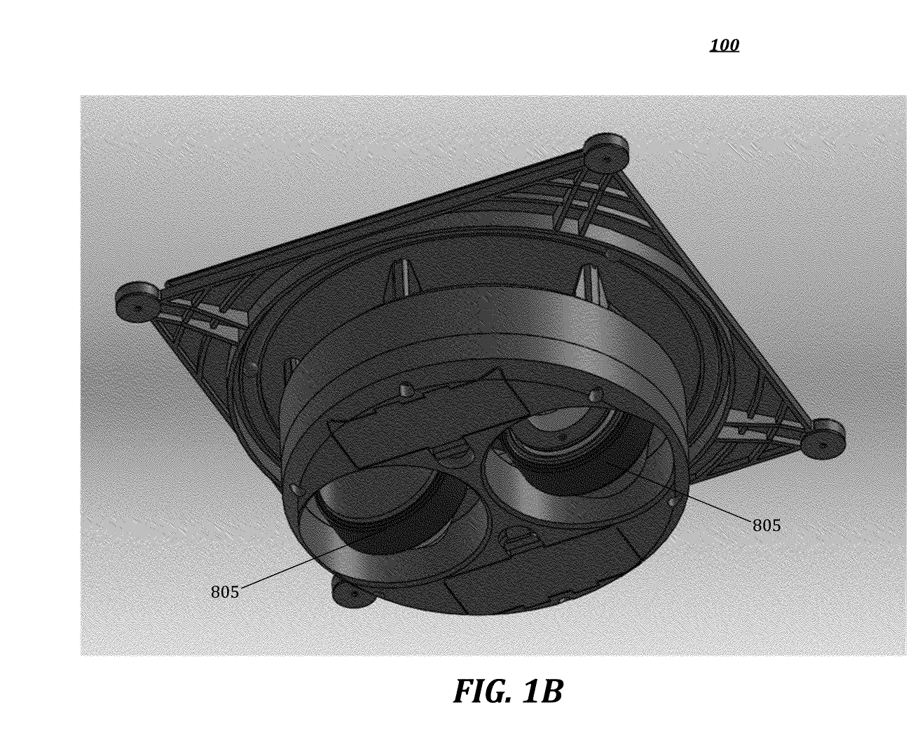

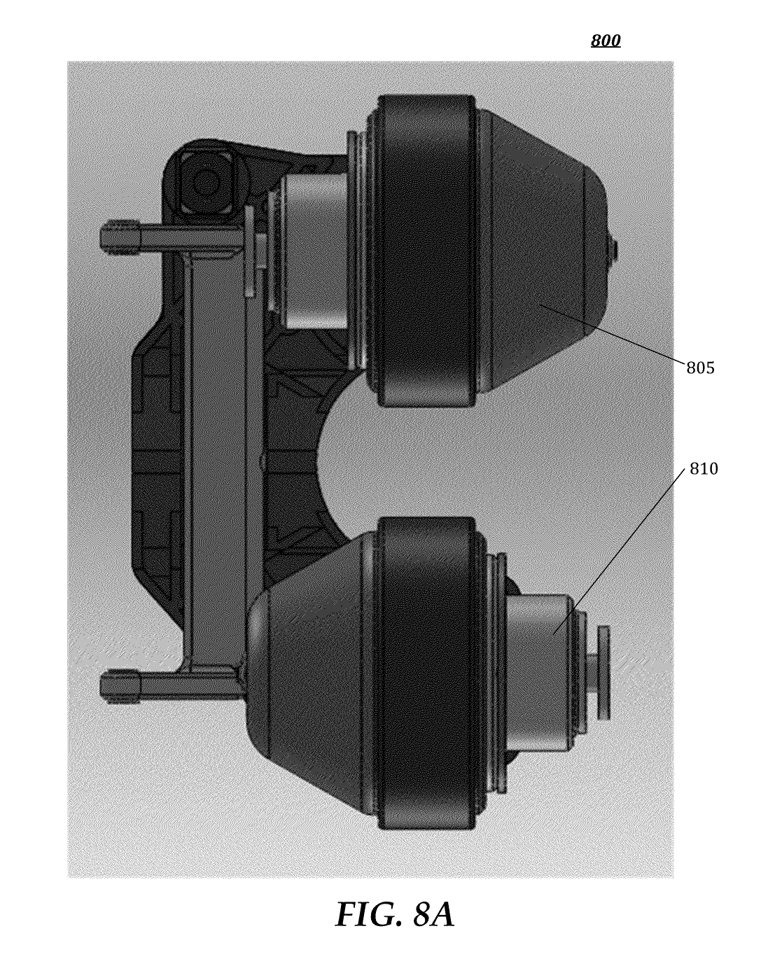

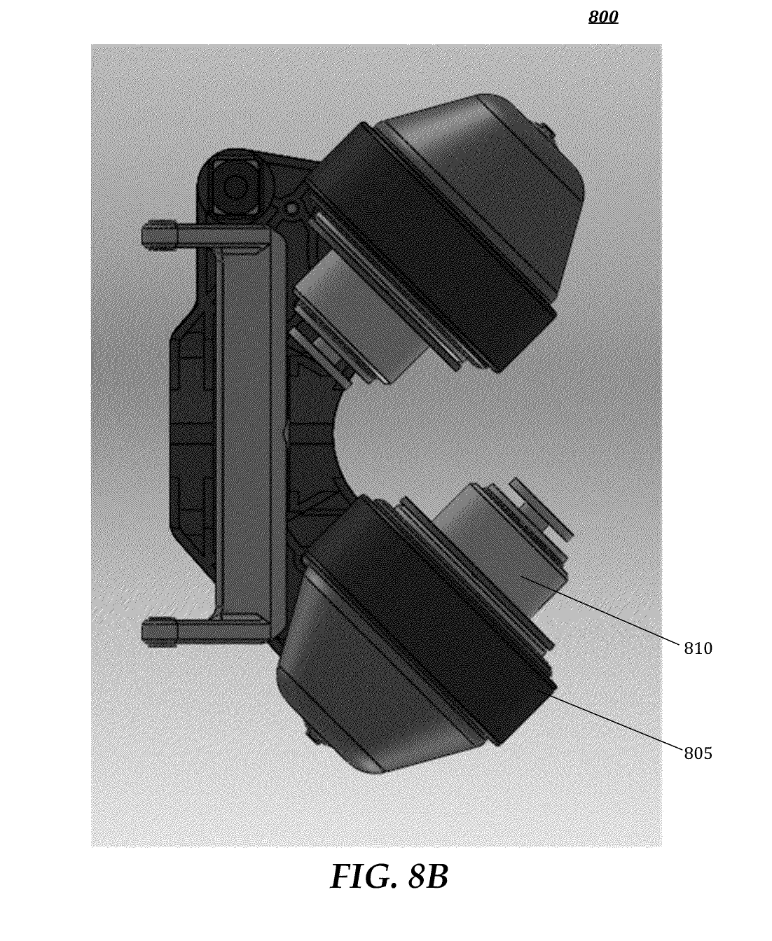

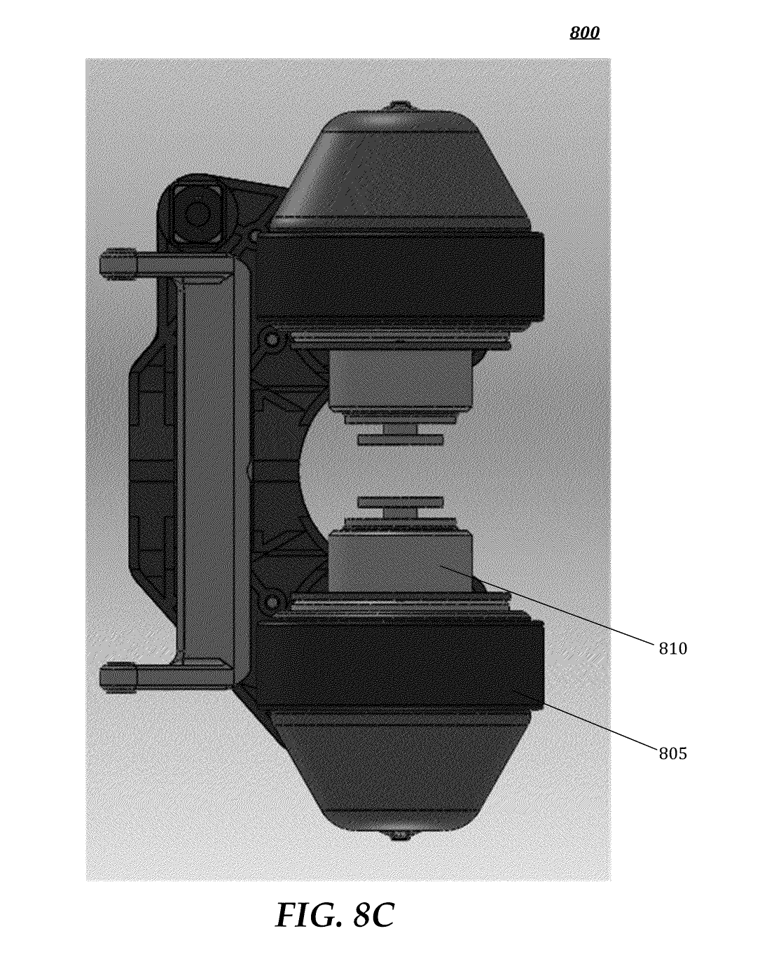

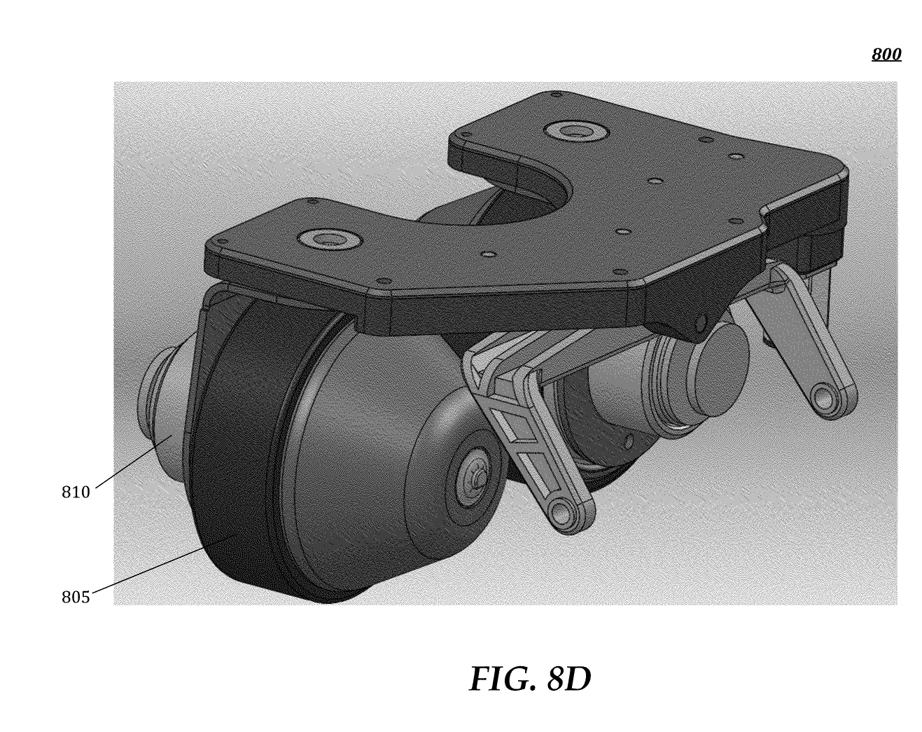

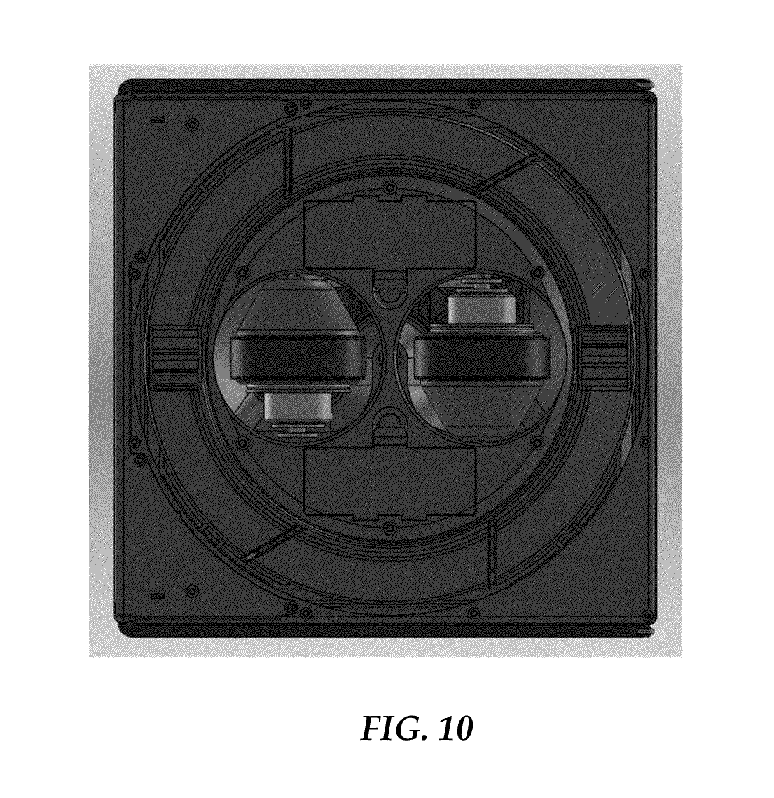

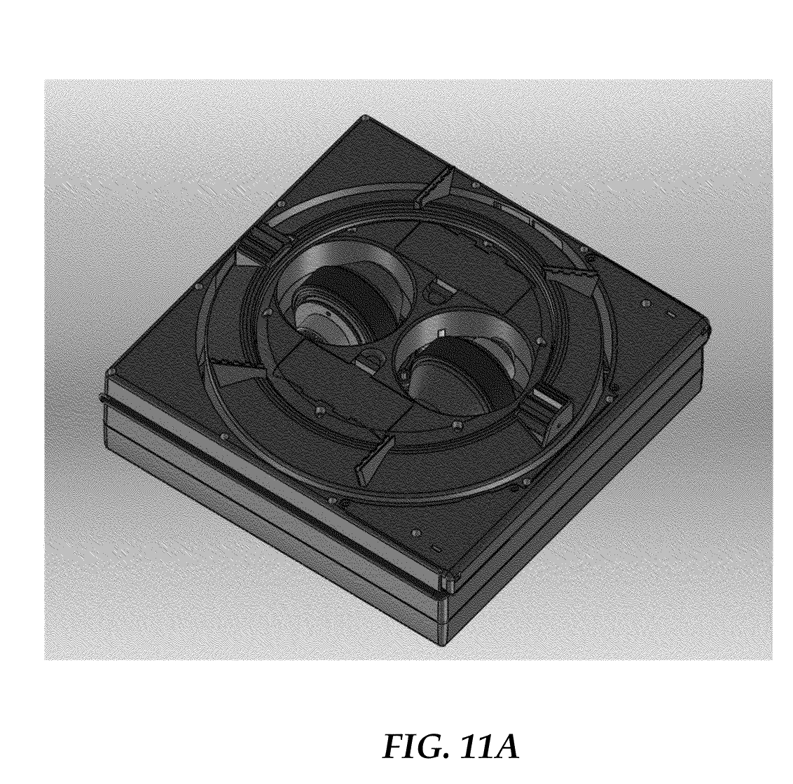

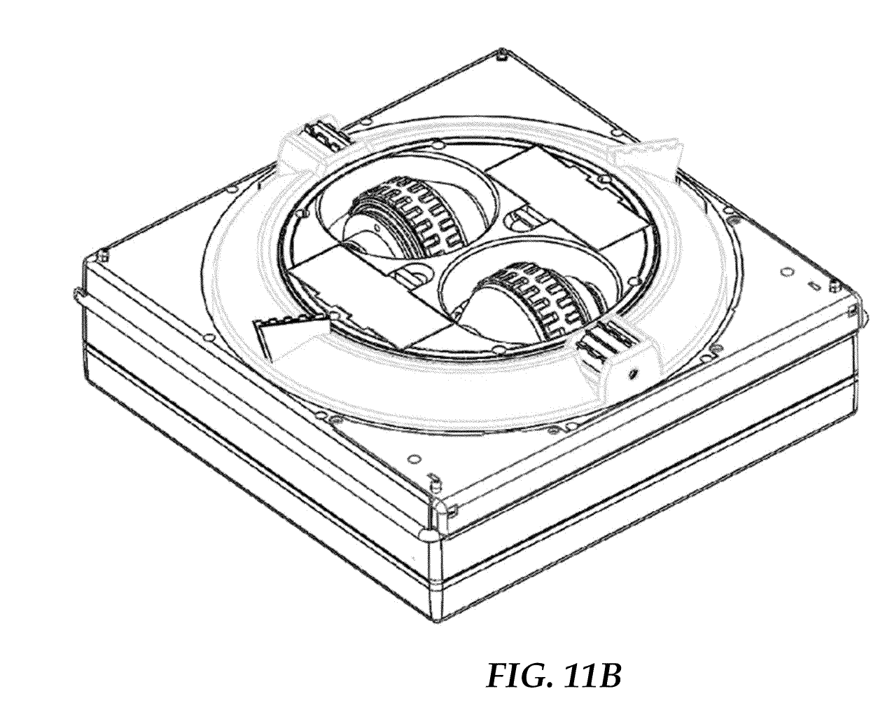

The mobility platform may comprise a central body “first body” 100 as shown in FIGS. 1A and 1B. In some embodiments the body may comprise one or more wheels, batteries, 3 motors for mobility, and one additional motor to drive a fan and cleaning mechanism. The wheels may be both driven and steered. An example of embodiment of a wheel system 800 is shown in FIGS. 8A, 8B, 8C, and 8D. In some embodiments, a steering mechanism may steer both wheels at the same time through a geared mechanism. This mechanism may utilize a timing belt or chain, or any other mechanism that does not allow the steered wheels to lose orientation with each other. This mechanism may comprise a system is often called a synchro drive. Each wheel 805 may have its own independent motor 810 that allows each wheel 805 to be driven at its own speed to allow differential steering in addition to synchronous steering. Each wheel 805 may be steered through a full 360 degrees of freedom. This system may be used to enable the robot to move side-to-side on a stair without turning the body of the vehicle. This may enable the platform to be square for improved corner cleaning ability as well as additional volume with which to house the stair climbing system, cleaning apparatus, batteries, and control system. Each corner of the underside of the platform may comprise a high-speed air jet, as shown in FIGS. 10, 11A, and 11B.

These jets may continually direct debris to the middle to be picked up without clogging with hair, as side brushes often do.

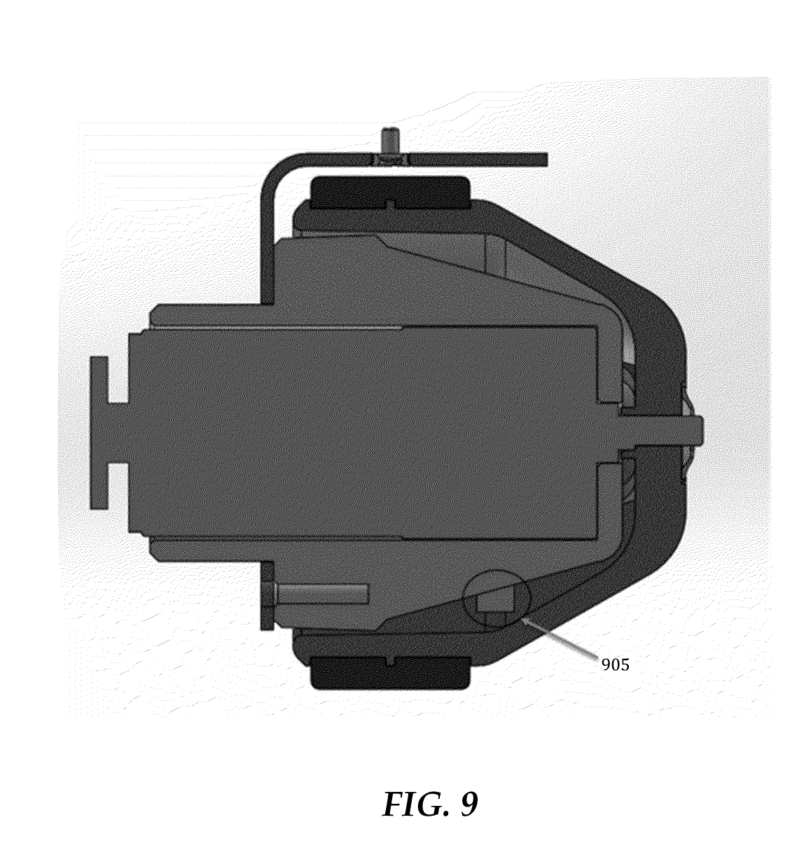

Optical tracking sensors 905 may be located in each wheel and facing the ground, as shown in FIG. 9. In some embodiments, the optical tracking sensors may utilize infrared (IR) sensing. In further embodiments, the wheel assembly may be IR clear (enabling IR to pass through) to allow this to function. By being located in the wheels, the distance from the sensor to ground may always be maintained/minimized, thus improving tracking accuracy. The sensors 905 may track the actual distance traveled by each wheel. In addition, encoders located on each wheel motor may indicate the number of rotations of each wheel. A tracking system comprising at least one encoder and at least one optical tracking device per wheel may ensure accurate odometry. This information may be provided to a software application. Using this information, the platform may build a map of its surroundings over time.

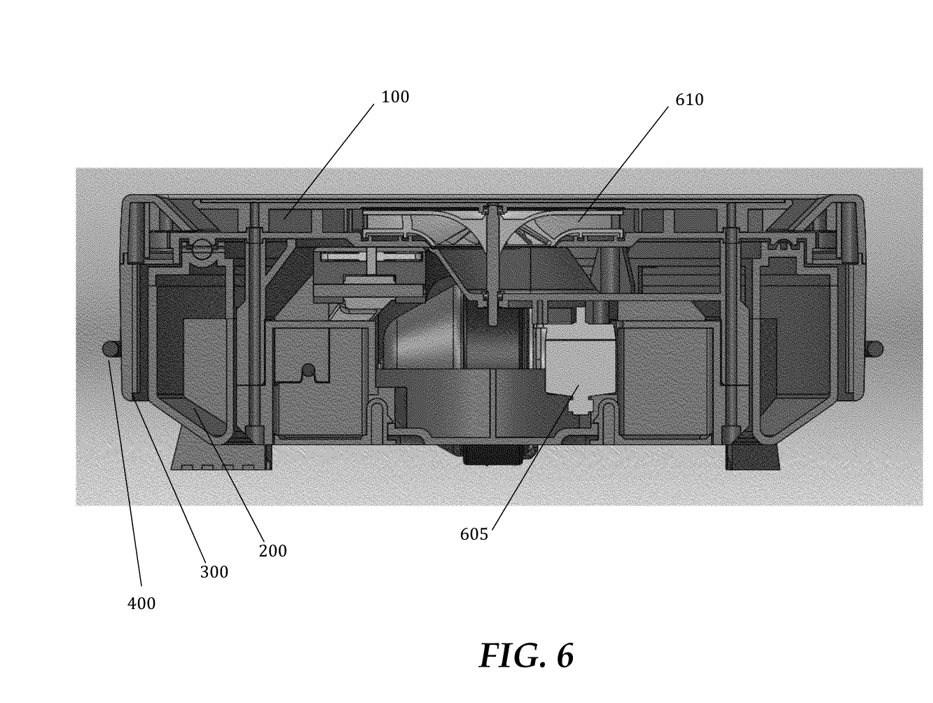

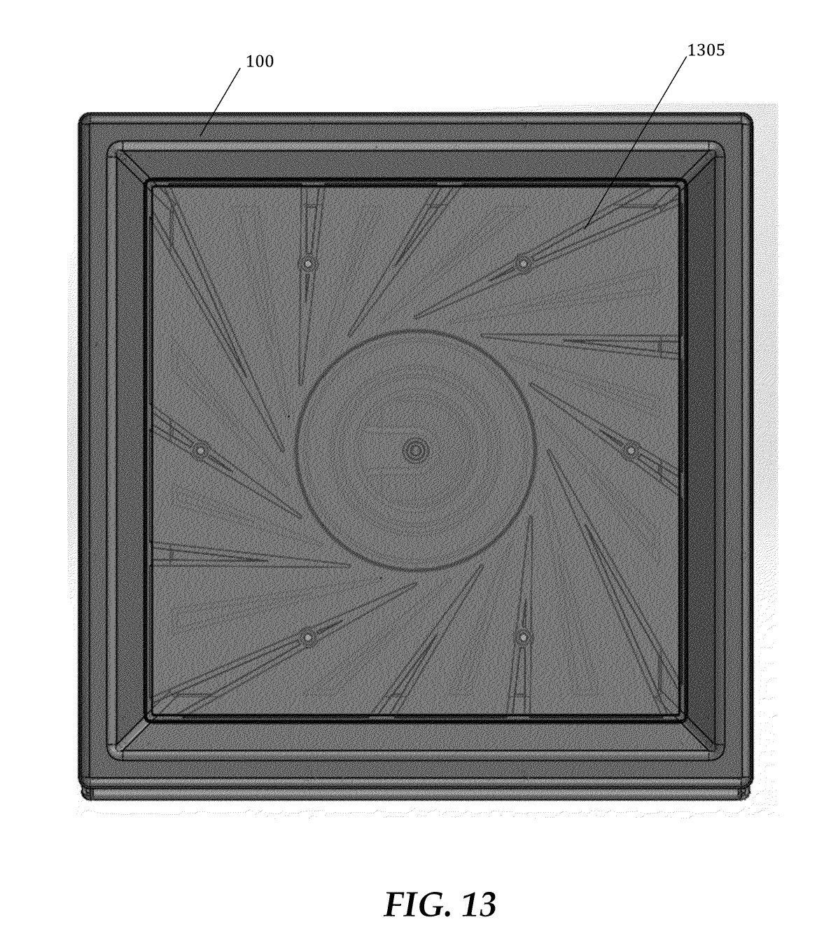

FIG. 6 illustrates a motor 605 used for cleaning, which may drive a fan 610. In some embodiments, the fan 610 may be centrally located. Further, the fan 610 may be mounted in the central body 100. This fan may exhaust through a diffuser (e.g. radial 360 degree diffuser 1305, as illustrated in FIG. 13) to regain static pressure. This function may also be performed by a scroll. However, the radial diffuser 1305 may allow greater structural integrity as well as a source of fast moving area for corner cleaning air jets directed at the floor from each corner of the chassis. The radial diffuser 1305 may also be quieter than the scroll. The central cleaning motor 610 may further be configured to drive a rotary bin/cleaning mechanism that rotates around this central mobility platform.

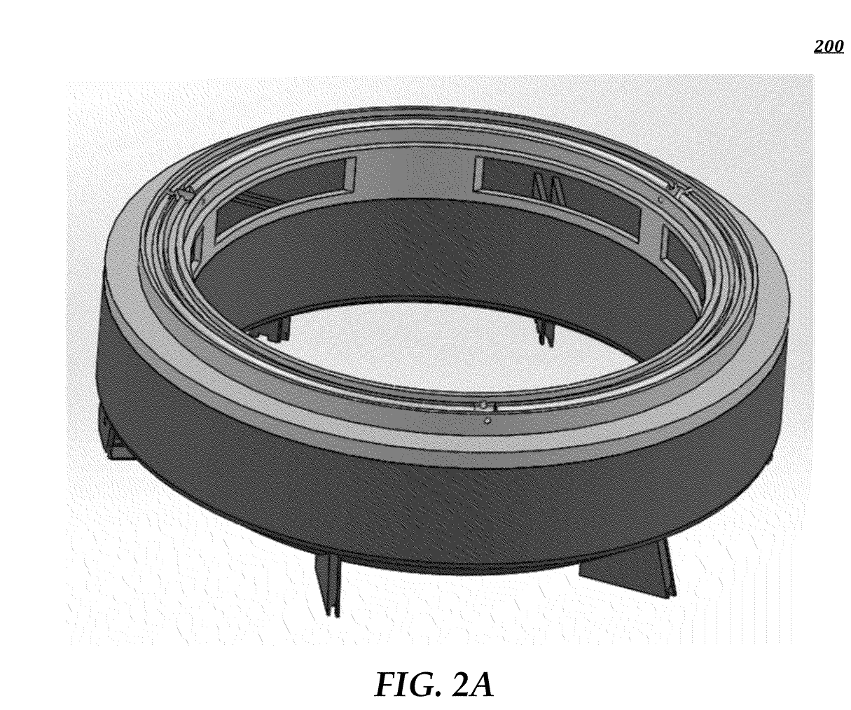

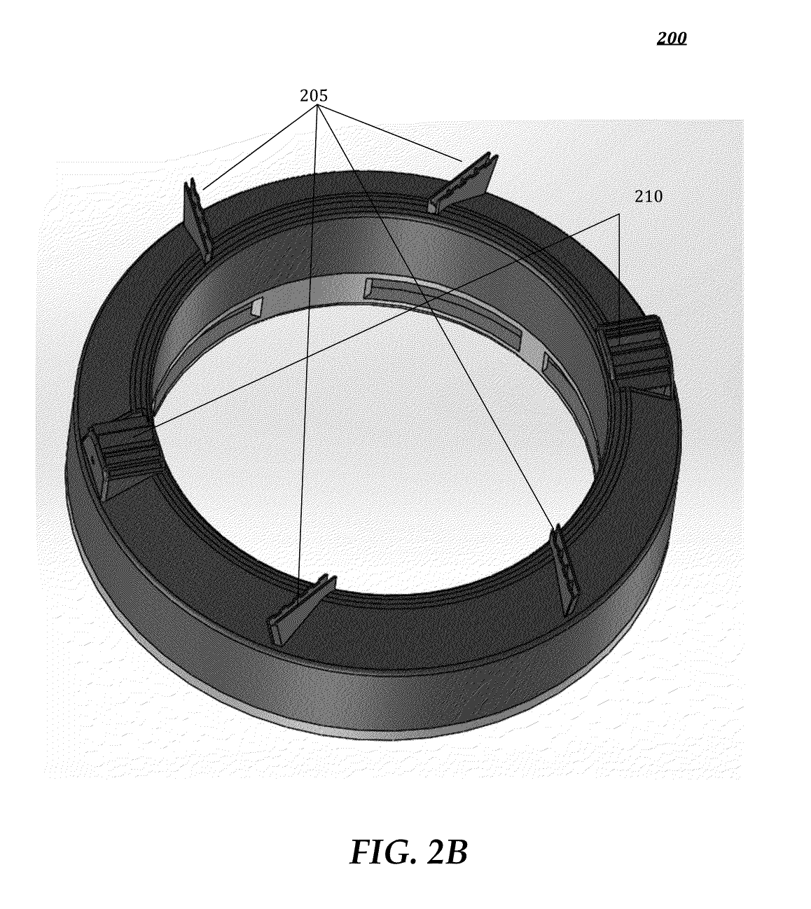

The cleaning mechanism may utilize components for cleaning (picking up debris from the floor) in addition to storing this debris during use. Cleaning and storing the debris may be accomplished by a second body 200, as shown in FIGS. 2A and 2B. The second body 200 may be round and surround the periphery of the central body 100, forming a ring with one or more vacuuming devices or other cleaning devices. The vacuum devices or other cleaning devices may include, but are not limited to, one or more squeegee vacuums 205, one or more short but traditional roller bars configured to pick up larger objects 210, or a deformable belt/track configured to pick up larger objects, a piece of Swiffer® material (or the like) for hard surfaces, etc. These cleaning devices may be fixed radially around this ring (“bin”) and do not move relative to the bin. Debris picked up by these cleaning devices may then be deposited into an internal volume of the ring for later removal/auto-evacuation. In the configuration the internal volume may be higher than other cleaning robots (e.g., one liter) despite the smaller overall size of the robot.

This cleaning ring 200 may rotate around the periphery of the vehicle (as driven by the centrally-housed motor) to allow smaller distributed systems to clean the full width of the vehicle as the vehicle travels. In this way, it may operate in a similar manner as a lawnmower that is able to cover a lawn by rotating a blade. Further, the rotating cleaning bin may allow much higher air velocities within the cleaning system than can be obtained with a single large cleaning bar with the same power/air velocities. The cleaning ring may rotate with a normal axle or a hub-less design using rolling elements or otherwise low friction surfaces to constrain this motion to be rotational.

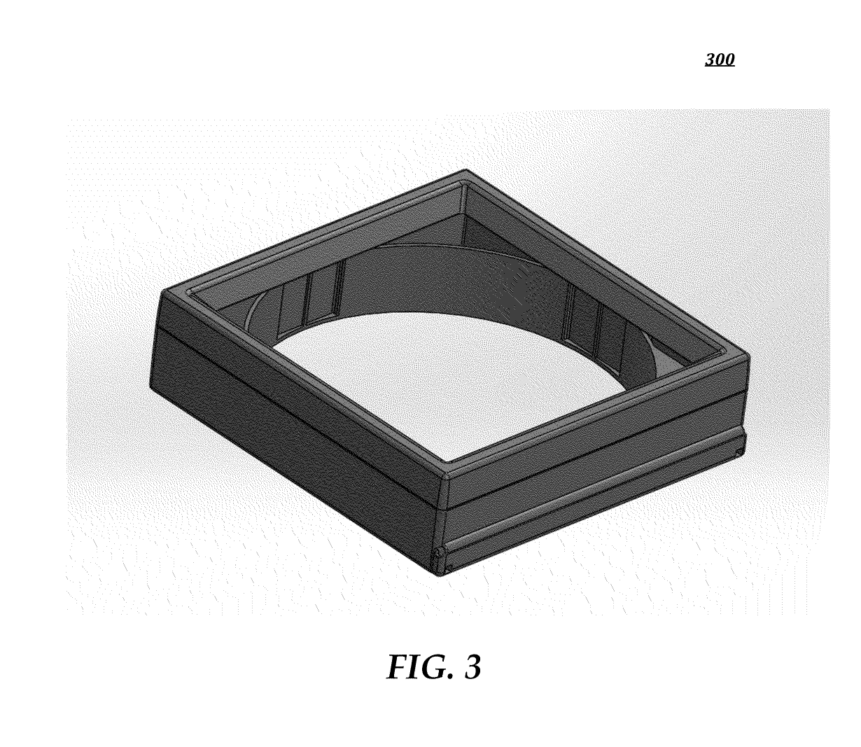

FIG. 3 illustrates an exterior body 300. The exterior body 300 may match a square outer form factor of the platform. In further embodiments, a round shape or various other shapes may be employed as well. This exterior body 300 may be mounted to the central body 100 and move independently of the second body 200 such that the second body 200 is free to rotate. The exterior body 300 may be free to move a few millimeters in each direction, but may be constrained vertically. This body is may utilize low friction mounting locations and springs that return this system to the start position after any collisions. In this way this outer body may act as a bumper. Further embodiments may comprise sensors configured to detect nearby objects for collision detection. This third body 300 may further comprise IR sensors facing downwards for cliff detection, and outward-facing IR sensors around the periphery for wall following/detection.

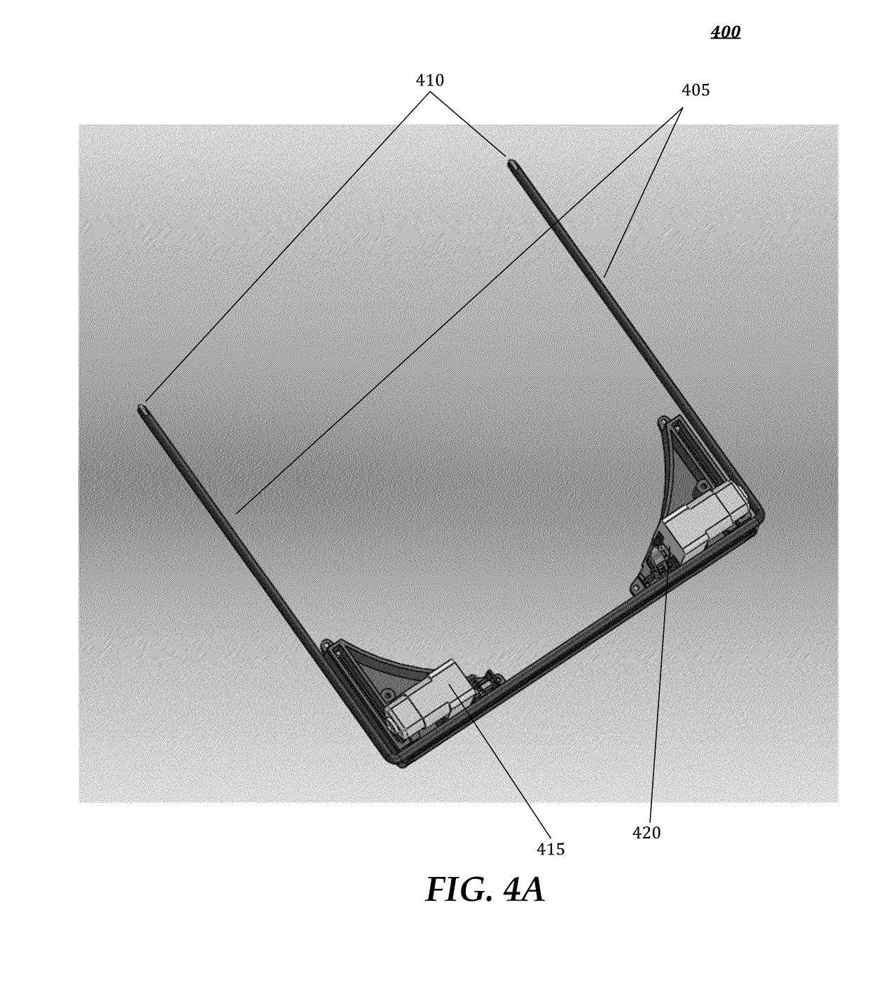

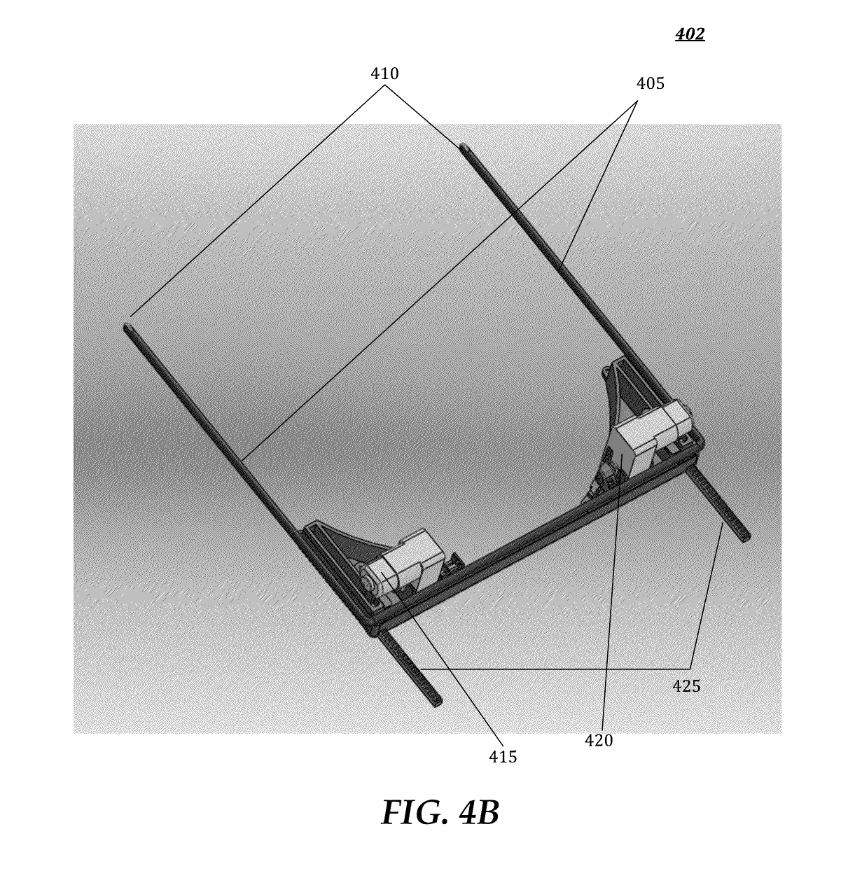

The platform may further comprise a stair climbing mechanism 400 in first position, as shown in FIG. 4A, which may be mounted to the third body 300. In some embodiments, a control board (e.g., controller 1400) may be mounded on the stair climbing mechanism, while in further embodiments, the control board may be mounted elsewhere. The stair climbing mechanism 400 may comprise one or more solid arms 405. The arms 405 may be located on either side of the platform. The arms 405 may further be aligned with each other and rotate at the same time. Some embodiments may comprise a single metal rod that wraps around three sides of the square vehicle to provide two arms 405, as shown in FIGS. 4A and 4B. In this way, the arms 405 may be rigid and rotate at the same time. Each arm 405 may attach to a small wheel 410 or low friction element at the end. This module also contains a gear motor 415 to drive this arm, and an additional gear motor 420 used to charge a spring mechanism configured to enable stair climbing upon release. The spring mechanism may comprise, for example, a rack-and-pinion mechanism to compress one or more springs. FIG. 4A illustrates a first configuration when the spring is compressed. FIG. 4B illustrates a second configuration 402 in which the springs have been released. Upon a release of the springs, one or more posts 245 may be projected in a way to cause a force in a direction upward and towards the top of the stair. This force may be used to move the vehicle to the top of the stair. For example, the vehicle may reach the top of the stair in a way similar to that of a pole vaulter. In further embodiments, the stair climbing mechanism may be mounted in a plurality of ways. For example, arms 405 and spring mechanism may attach to different components of the vehicle (e.g., arms 405 may attach to the first body 100, while the spring mechanism may attach to the outer body 300).

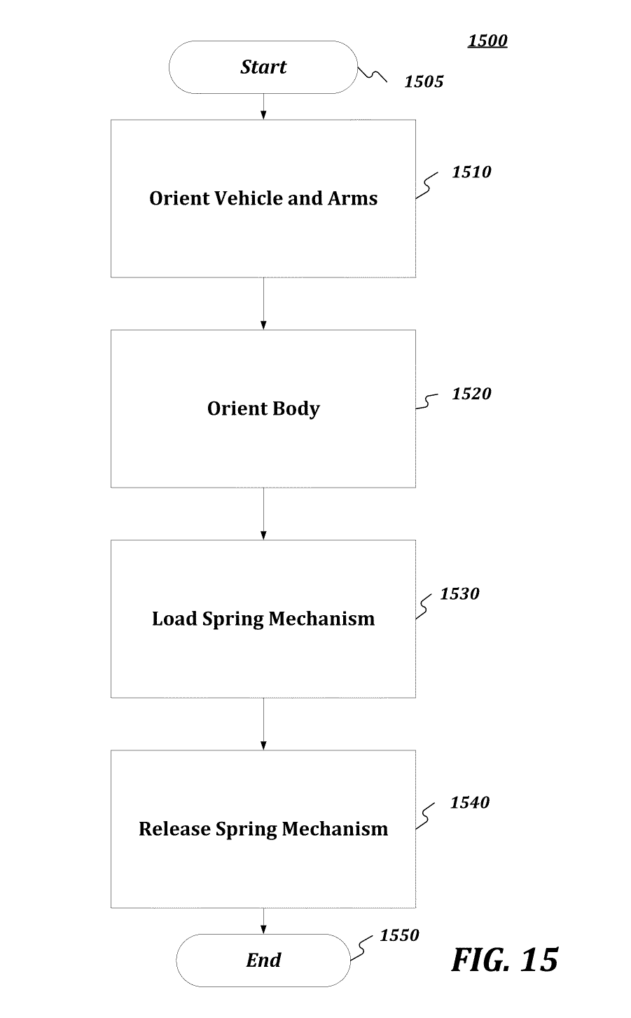

FIG. 15 is a flow chart setting forth the general stages involved in a method 200 consistent with an embodiment of the disclosure for climbing stairs. Although the stages illustrated by the flow charts are disclosed in a particular order, it should be understood that the order is disclosed for illustrative purposes only. Stages may be combined, separated, reordered, and various intermediary stages may exist. Accordingly, it should be understood that the various stages illustrated within the flow chart may be, in various embodiments, performed in arrangements that differ from the ones illustrated. Moreover, various stages may be added or removed from the flow charts without altering or deterring from the fundamental scope of the depicted methods and systems disclosed herein. Ways to implement the stages of method 1500 will be described in greater detail below.

Method 1500 may begin at starting block 1505 and proceed to stage 1510, where the vehicle may approach a stair and place the arms 405 against the stair's base.

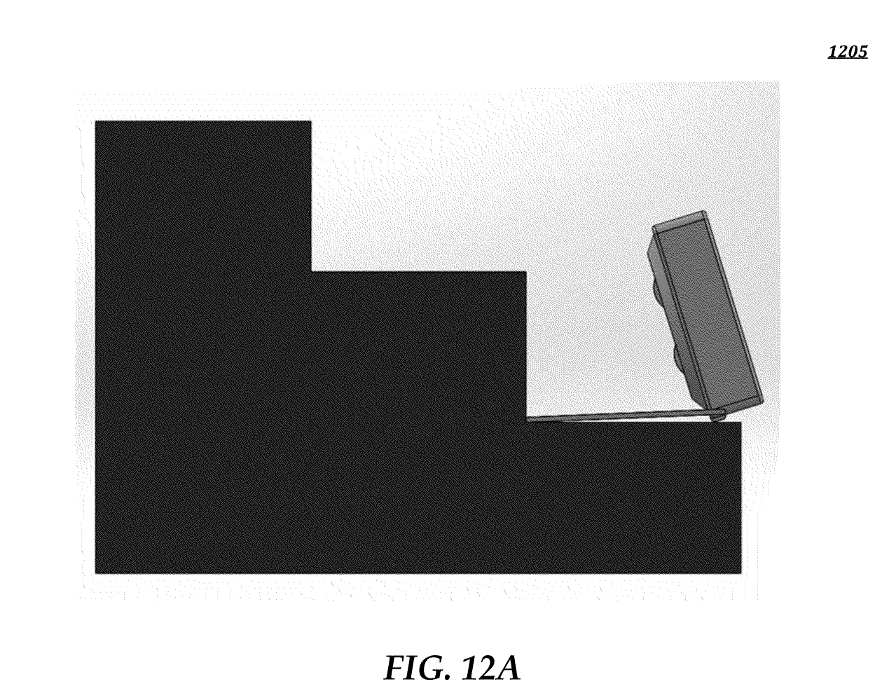

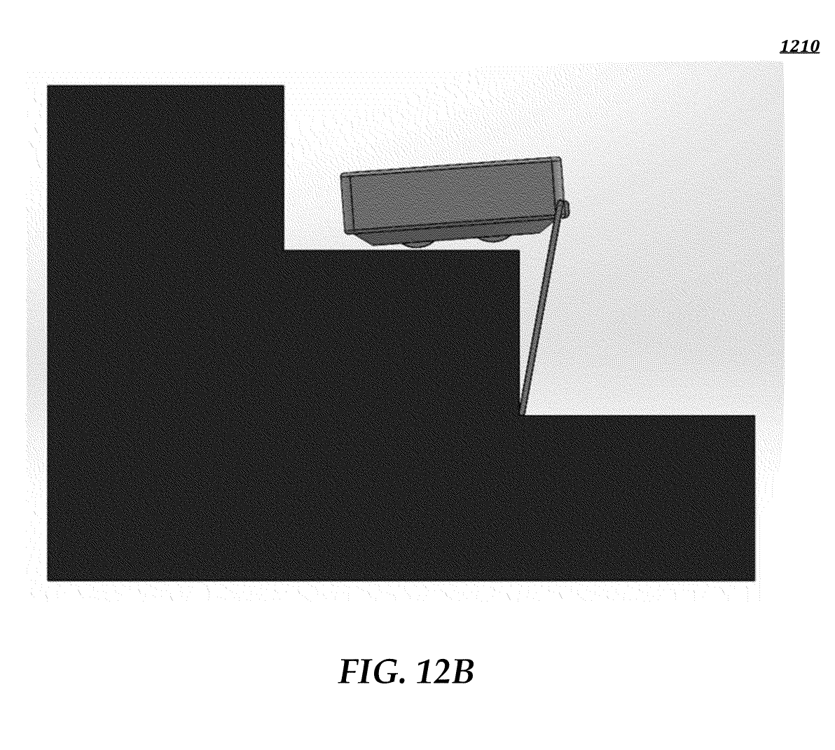

From stage 1510, method 1500 may proceed to stage 1520, where the vehicle may orient itself for climbing. For example, the vehicle may rotates the arms 405 down such that the rest of the vehicle is rotated at an angle for climbing the stair. In some embodiments, the angle may be about 80 degrees from horizontal, as shown in FIG. 12A, in a first configuration 1205. The angle can be adjusted to any angle between 0 and 90 degrees to provide adequate balance for the vehicle, while enabling the vehicle to clear the stair. In some embodiments, the control board may calculate an optimal angle.

From stage 1520, where the vehicle orients itself for climbing, method 1505 may proceed to stage 1530, where the vehicle may load the spring mechanism. For example, the spring system may be placed at the back of the vehicle, and may generate enough stored spring energy to provide a necessary force to launch the vehicle upward. This spring system may be charged by a gear motor, as shown in FIG. 4A and may utilize a rack-and-pinion system.

From stage 1530 where the vehicle loads the spring mechanism, method 1500 may proceed to stage 1540, where the vehicle may release the spring mechanism to ascend the stair. For example, the release of the springs may cause posts 425 to extend from the vehicle, forcing the vehicle upward and in a rotating direction such that the vehicle may reach a second configuration 1210, as shown in FIG. 12B. Posts 425 may be retracted to reset after the stair has been cleared. Once the vehicle releases the spring mechanism and ascends the stair, method 1500 may end at stage 1550.

The arms being placed at the base of the stair tread may force the trajectory of the vehicle into a controlled arc in the same way a pole vaulter clears a bar. The length of the arms may exceed the standard height of a stair riser (the standard of which is 7 inches) enough that the vehicle may be able to reach a next stair. In some embodiments, the arms 405 may be over 9″ long to allow for variations of stair height, the vehicle successfully lands on the next stair tread. These arms may be any length between 7 and 9″ in order to both clear the riser and allow the vehicle to fit on a standard 10″ tread. The arms 405 may be embodied in various lengths for other stair configurations. Wheels located in the central body may be driven forward with the landing to ensure vehicle plants fully on the tread. The arms are then rotated to the start position allowing the robot to move normally again to either clean the stair tread, or reach the next higher surface obtained, and the process is repeated until the full height of stairs has been ascended.

To climb back down the stairs, the arms may be rotated from the edge of each stairs until they once again meet the intersection between stair tread/floor and stair riser. The robot then moves forward using these arms to control the motion and rotated to maintain controlled descent of the vehicle until it reached the next lower tread/flooring surface, until the full stair case has been descended.

This unique stair climbing mechanism may allow the vehicle to clean the actual stair tread in addition to climbing them. This is distinctly different from other systems such as track or multi-wheel based units that can climb stairs but not pause on each tread for cleaning. Also, track or multi-wheel based systems have to represent the furthest outboard portion of the vehicle to ascend a stair which would then preclude the use of a bumper system. Track based systems with flipper arms also require the track or set of wheels to directly contact a stair tread in order to climb, which again does not work with a fully enclosed bumper system needed in a consumer environment. Embodiments of the present disclosure may compromise the ability to add a cleaning system that can clean the full width of the vehicle. For the above reasons this arm, and spring system vaulting/trajectory forcing system is truly unique from other arm based designs.

This stair climbing ability may then be further used to enable this vehicle to climb onto a docking station that is the height and width of a stair tread and roughly the width of the vehicle. The autonomous floor cleaner may then deposit its contents into the larger receptacle it has ascended, charge, and continue cleaning.

Embodiments consistent with the present disclosure may be used to clean all floor types, including hard (wood, tile, linoleum, brick, etc.), or carpeted. They may also be used to clean stairs, or deliver a payload from one floor to another, or enable telepresence that is not limited to a single level. The unique design of this cleaning system enables the vehicle to treat each stair as a separate obstacle and does not have to ascend the entire flight of stairs in a single operation such as track based systems do.

II. Controller Architecture

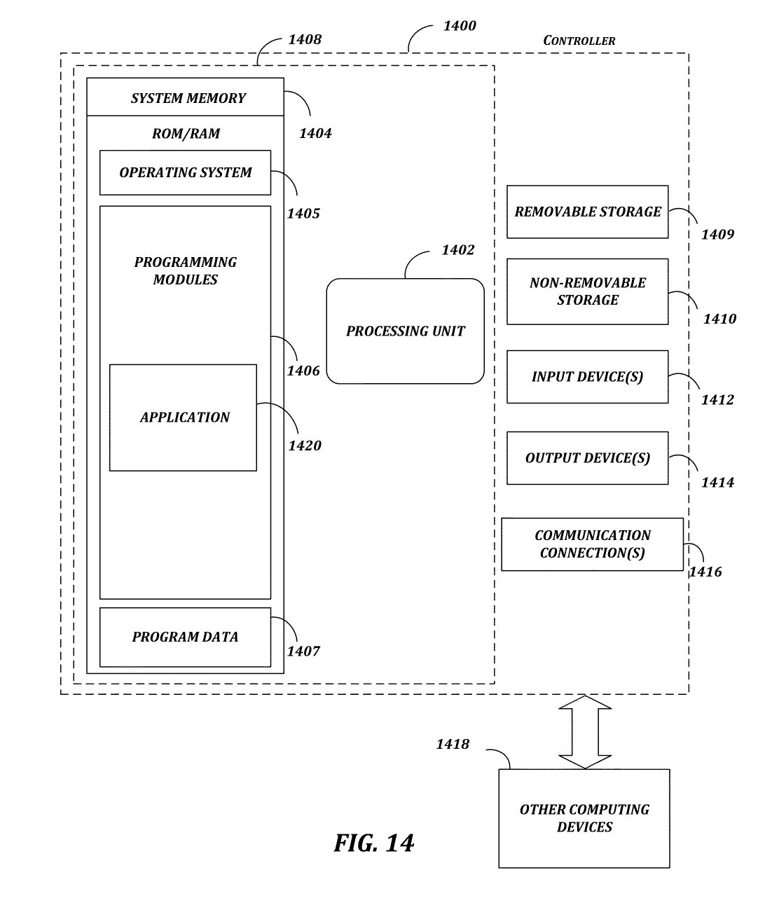

FIG. 14 is a block diagram of a system including a controller 1400 (also referred to as a controller). Controller may be configured to perform various operations in controlling the systems and devices of the present disclosure. Consistent with an embodiment of the disclosure, the aforementioned embodiments may comprise a processing unit and a memory storage configured to operate the device. Operation of the device may comprise, but not be limited to, for example, a method comprising: placing a front part of at least one arm against a base of an elevated surface; orienting a body that is connected to a rear part of the at least one arm such that the body's center of mass is higher than the base of the stair; loading a spring, wherein one side of the spring is connected to the at least one arm and the other side of the spring is connected to the body; releasing the spring's load, wherein the releasing of the spring causes the body to impact with the at least one arm, thereby causing a rotational motion such that the body vaults over the elevated surface; and rotating the at least two arms to orient the at least two arms at the base of a second stair, wherein rotating the at least two arms comprises using an electric motor to rotate the two arms.

The processing unit and memory storage may be implemented in a controller, such as controller 1400 of FIG. 14. Any suitable combination of hardware, software, or firmware may be used to implement the memory storage and processing unit. For example, the memory storage and processing unit may be implemented with controller 1400 or any of other controllers 1418, in combination with controller 1400. The aforementioned system, device, and processors are examples and other systems, devices, and processors may comprise the aforementioned memory storage and processing unit, consistent with embodiments of the disclosure.

In a basic configuration, controller 1400 may include at least one processing unit 1402 and a system memory 1404. The processing unit may comprise a programmable chip. Depending on the configuration and type of controller, system memory 1404 may comprise, but is not limited to, volatile (e.g. random access memory (RAM)), non-volatile (e.g. read-only memory (ROM)), flash memory, or any combination. System memory 1404 may include operating system 1405, one or more programming modules 1406, and may include a program data 1407. Operating system 1405, for example, may be suitable for controlling controller 1400's operation. In one embodiment, programming modules 1406 may include stair climbing control and odometry. Furthermore, embodiments of the disclosure may be practiced in conjunction with a graphics library, other operating systems, or any other application program and is not limited to any particular application or system. This basic configuration is illustrated in FIG. 14 by those components within a dashed line 1408.

Controller 1400 may have additional features or functionality. For example, controller 1400 may also include additional data storage devices (removable and/or non-removable) such as, for example, magnetic disks, optical disks, or tape. Such additional storage is illustrated in FIG. 14 by a removable storage 1409 and a non-removable storage 1410. Computer storage media may include volatile and nonvolatile, removable and non-removable media implemented in any method or technology for storage of information, such as computer readable instructions, data structures, program modules, or other data. System memory 1404, removable storage 1409, and non-removable storage 1410 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by controller 1400. Any such computer storage media may be part of device 1400. Controller 1400 may also have input device(s) 1412 such as a keyboard, a mouse, a pen, a sound input device, a touch input device, etc. Output device(s) 1414 such as a display, speakers, a printer, etc. may also be included. The aforementioned devices are examples and others may be used.

Controller 1400 may also contain a communication connection 1416 that may allow device 1400 to communicate with other controllers 1418, such as over a network in a distributed computing environment, for example, an intranet or the Internet. Communication connection 1416 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 1404, including operating system 1405. While executing on processing unit 1402, programming modules 1406 (e.g., stair climbing control application 1420) may perform processes including, for example, one or more of the actions as described above. The aforementioned process is an example, and processing unit 1402 may perform other processes. Other programming modules that may be used in accordance with embodiments of the present disclosure may include electronic mail and contacts applications, word processing applications, spreadsheet applications, database applications, slide presentation applications, drawing or computer-aided application programs, etc.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, multiprocessor systems, microprocessor-based or programmable consumer electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

All rights including copyrights in the code included herein are vested in and the property of the Applicant. The Applicant retains and reserves all rights in the code included herein, and grants permission to reproduce the material only in connection with reproduction of the granted patent and for no other purpose.

III. Claims

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as example for embodiments of the disclosure.

Insofar as the description above and the accompanying drawing disclose any additional subject matter that is not within the scope of the claims below, the disclosures are not dedicated to the public and the right to file one or more applications to claims such additional disclosures is reserved.

I claim the following:

1. A method comprising:
placing a front part of at least one arm against a base of an elevated surface;
orienting a body that is connected to a rear part of the at least one arm such that the body's center of mass is higher than the base of the stair;
loading a spring, wherein one side of the spring is connected to the at least one arm and the other side of the spring is connected to the body;
releasing the spring's load, wherein the releasing of the spring causes the body to cause a force against the at least one arm, thereby causing a rotational motion such that the body vaults over the elevated surface.

2. The method of claim 1, further comprising:
rotating the at least two arms to orient the at least two arms at the base of a second stair.

3. The method of claim 2, wherein rotating the at least two arms comprises using an electric motor to rotate the two arms.

4. The method of claim 1, wherein loading the spring comprises using a rack and pinion to load the spring.

5. The method of claim 1, wherein orienting the body comprises using a means to orient the body to 80 degrees with respect to a horizontal.

6. An apparatus comprising:
a body comprising:
a power source,
at least one wheel,
at least one motor coupled to the power source and the at least one wheel and configured to drive the at least one wheel;
at least one arm coupled to the body and to an arm motor configured to rotate around the body, the at least one arm comprising an end configured to sit against a base of an elevated surface, the arm being; and
a spring system configured to be loaded by a spring motor, wherein a release of the spring system enables a kinetic energy necessary to propel the body over the elevated surface by pivoting around the end configured to sit against the base of the elevated surface.

7. The apparatus of claim 6, further comprising at least one of the following: at least one optical sensor and at least one encoder coupled to the at least one wheel, wherein feedback from the at least one of the following: the at least one optical sensor and the at least one encoder, is read by a controller and used in a calculation of odometry.

8. The apparatus of claim 6, further comprising:
a motor coupled to a fan and configured to create a negative pressure for removing debris from the elevated surface; and
a bin for storing the debris.

9. The apparatus of claim 8, wherein the bin is configured in a ring around the body.

10. The apparatus of claim 9, wherein the bin is configured to rotate around the body.

11. The apparatus of claim 6, further comprising at least two wheels, including the at least one wheel, wherein the at least two wheels are oriented with respect to each other.

12. The apparatus of claim 6, wherein the at least one wheel is configured to rotate 360 degrees.

13. The apparatus of claim 6, wherein the body comprises a plurality of corners and a jet on each of the plurality of corners configured to move debris to a center of the apparatus.

14. The apparatus of claim 8, further comprising a radial diffuser.

15. The apparatus of claim 6, further comprising at least one of the following: a squeegee vacuum, a roller bar configured to pick up debris, a deformable belt configured to pick up debris, and a piece of a material for attracting the debris.

16. The apparatus of claim 6, wherein the at least one arm is longer than a height of the elevated surface.

17. The apparatus of claim 6, further comprising an exterior body configured to act as a bumper.

18. The apparatus of claim 6, further comprising at least one sensor to detect at least one of the following: a wall and a cliff.

19. A system including the apparatus of claim 6, further comprising:
a docking station, wherein the docking station is configured to perform at least one of the following: provide power to the apparatus; and receive debris from the apparatus.
